(19) United States
(12) Patent Application Publication
(10) Pub. No.: US 2015/0012462 A1
(43) Pub. Date: Jan. 8, 2015

(54) Blending Methodology for Settling Swaption Volatility Cube and Prices

(71) Applicant: Chicago Mercantile Exchange Inc., Chicago, IL (US)

(72) Inventors: Jingbin Yin, Naperville, IL (US); Andrei Lopatin, Lisle, IL (US)

(21) Appl. No.: 14/310,476

(22) Filed: Jun. 20, 2014

Related U.S. Application Data
(60) Provisional application No. 61/837,495, filed on Jun. 20, 2013.
(60) Provisional application No. 61/952,652, filed on Mar. 13, 2014.

(51) Int. Cl. G06Q 40/06

(52) U.S. Cl. CPC G06Q 40/06
USPC 705/36 R

(57) ABSTRACT

Systems and methods are provided for determining volatility levels for swaptions. End of day volatility data from swaption dealers. The data may be blended to obtain averaged data and then a modified SABR model may be used to fit a smile to the data points. The modified SABR model models density instead of implied volatility.

The present application claims priority to U.S. provisional patent application Ser. No. 61/837,495, filed Jun. 20, 2013, and U.S. provisional patent application Ser. No. 61/952,652, filed Mar. 13, 2014, the entire disclosures of both applications are hereby incorporated by reference.

### FIELD OF THE INVENTION

Embodiments of the present invention relate to systems and methods for processing swaptions. More particularly, the invention provides mechanisms for determining pricing, volatility and margin requirements.

### DESCRIPTION OF THE RELATED ART

A swaption is an option to enter into an interest rate swap. In exchange for an option premium, the buyer gains the right but not the obligation to enter into a specified swap agreement with the issuer on a specified future date. Exemplary swaps are interest rate swaps. Trades involving swaptions are typically large but occur infrequently and may have nonstandard terms. Clearinghouses and other entities that clear trades require traders, such as traders of swaptions, to maintain performance bonds in margin accounts to cover risks associated with the portfolios. The clearinghouse (e.g., central counterparty to financial products) may use the performance bond to counter margin risk associated with the portfolio. Risks are analyzed to determine required initial margin amounts and maintenance margin amounts. A risk calculation module (or risk processor) may assist in the calculation. In some examples, values (e.g., swap DV01s, volatility values, etc.) and adjustments/factors (e.g., calendar charge adjustments, liquidity charge minimums, etc.) may be used to enhance the margin calculation.

Clearinghouses are structured to provide exchanges and other trading entities with solid financial footing. Maintaining proper margin amounts is an important part of the maintaining solid financial footing. The required margin amount generally varies according to the volatility of a financial instrument; the more volatility, the larger the required margin amount. This is to ensure that the bond will cover maximum losses that a contract would likely incur over a given time period, such as a single day. Required margin amounts may be reduced where traders hold opposite positions in closely correlated markets or spread trades.

Because trades involving swaptions occur infrequently, it has been difficult to accurately value swaptions, determine settlement prices, determine risks and set associated margin requirements.

Therefore, there is a need in the art for improved systems and methods for pricing swaptions, determining risks and setting initial and maintenance margin requirements.

### SUMMARY OF THE INVENTION

The present invention overcomes at least some of the problems and limitations of the prior art by providing improved systems and methods for determining volatility levels for swaptions. Various embodiments include receiving end of day volatility data from swaption dealers. The data may be blended to obtain averaged data and then a modified SABR model may be used to fit a smile to the data points. The modified SABR model may model density instead of implied volatility.

In some embodiments of the invention the modified SABR model uses an implied parameter to cause the volatility smile to pass through average values of the end of day volatility data.

In various embodiments, the present invention can be partially or wholly implemented on a computer-readable medium, for example, by storing computer-executable instructions or modules, or by utilizing computer-readable data structures.

Of course, the methods and systems disclosed herein may also include other additional elements, steps, computer-executable instructions, or computer-readable data structures. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a conventional volatility smile that shows the relationship between strike prices and volatility for options contracts, such as swaptions.

FIG. 3 illustrates a method that may be used to determine volatility levels of swaptions in accordance with an embodiment of the invention.

FIG. 4 illustrates an exemplary volatility smile created with a modified SABR model.

FIG. 5 illustrates an exemplary method for determining margin requirements in accordance with an embodiment of the invention.

FIG. 6 illustrates a continuation of the method started in FIG. 5.

FIG. 7 illustrates a method that may be used to determine volatility levels of swaptions, in accordance with an embodiment of the invention.

FIG. 8 illustrates an exemplary volatility smile created with the process shown in FIG. 7.

FIG. 9 illustrates a cumulative probability density function in accordance with an embodiment of the invention.

### DETAILED DESCRIPTION OF THE INVENTION

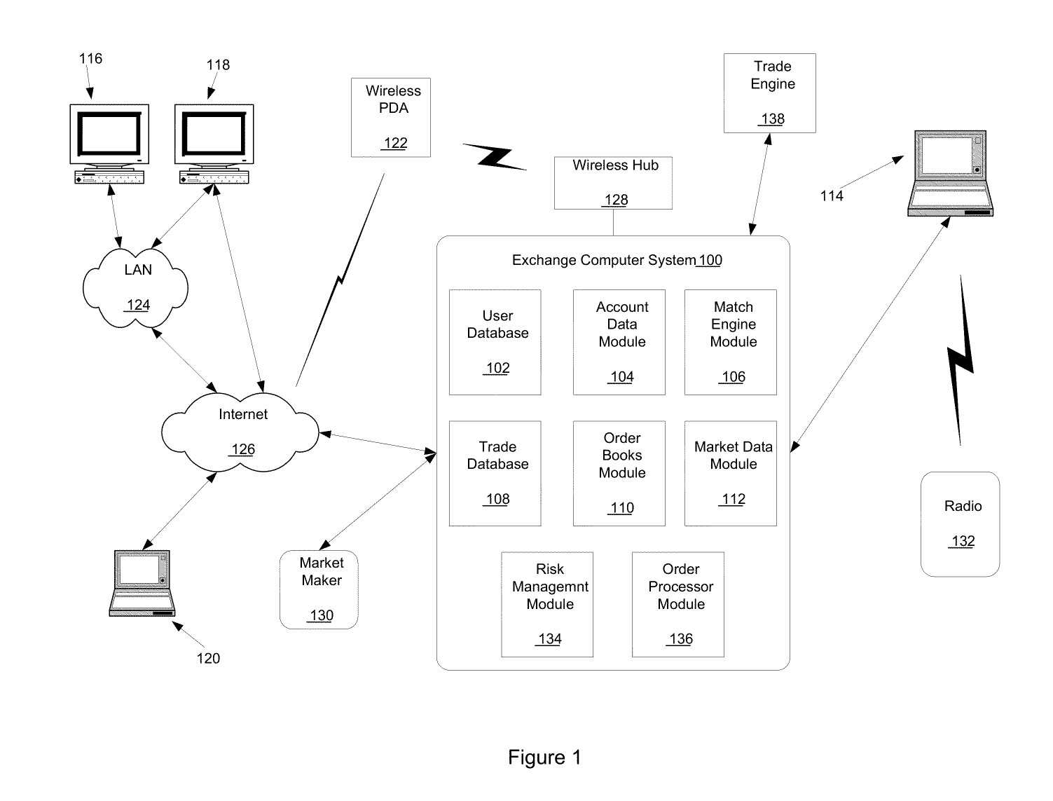

Aspects of the present invention may be implemented with computer devices and computer networks that allow users to exchange trading information. An exemplary trading network environment for implementing trading systems and methods is shown in FIG. 1.

An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100.

Exchange computer system 100 and computer device 114 may be connected via a Ti line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

In one alternative embodiment, a clearinghouse computer or computer system may be included. A clearinghouse or other entity that clears trades may use a clearinghouse computer or computer system to accurately calculate swaption settlement prices, values, risk and margin requirements.

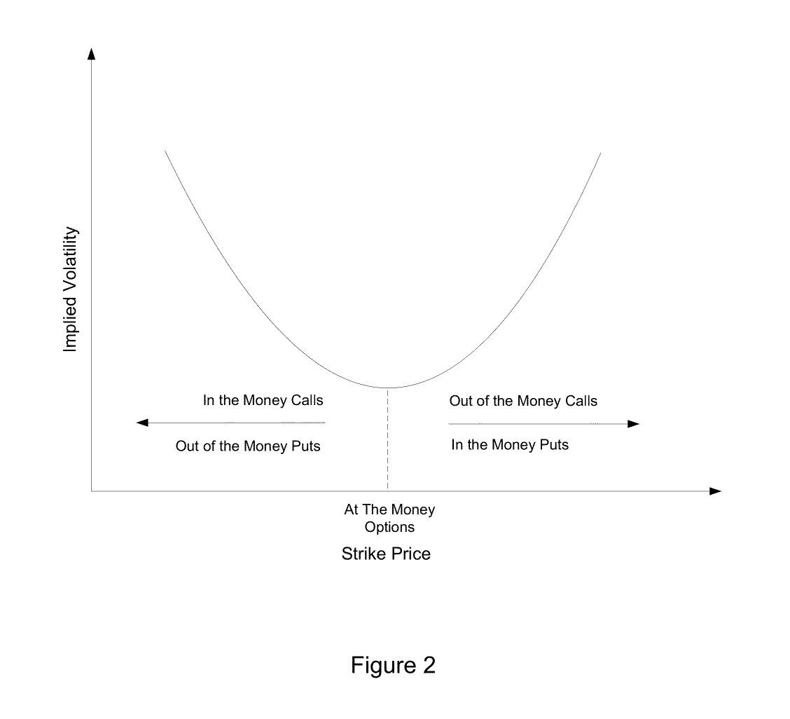

FIG. 2 illustrates a conventional volatility smile that shows the relationship between strike prices and volatility for options contracts, such as swaptions. As is shown in FIG. 2, the more an option is in-the-money or out-of-the-money, the greater its implied volatility may differ from the ATM option. Implied volatility of an option contract, such as a swaption may be related to a price of an option with an option pricing model, such as the Black-Scholes model. The SABR model is a stochastic volatility model, which attempts to capture the volatility smile in derivatives markets. The name SABR stands for “stochastic α, β, ν, ρ”, which are the parameters of the model.

In accordance with various embodiments of the invention methods of determining volatility levels for swaptions are provided. The volatility levels may be determined by first receiving some end of day volatility data from swap option dealers and then using one or more volatility models to interpolate missing data. One model may fit the data more strictly than another model. The model chosen may be a function of the use of the model. For example, when performing a mark to market process a model that strictly fits data may be used and when performing a margin requirement determination a model that less strictly fits data may be used.

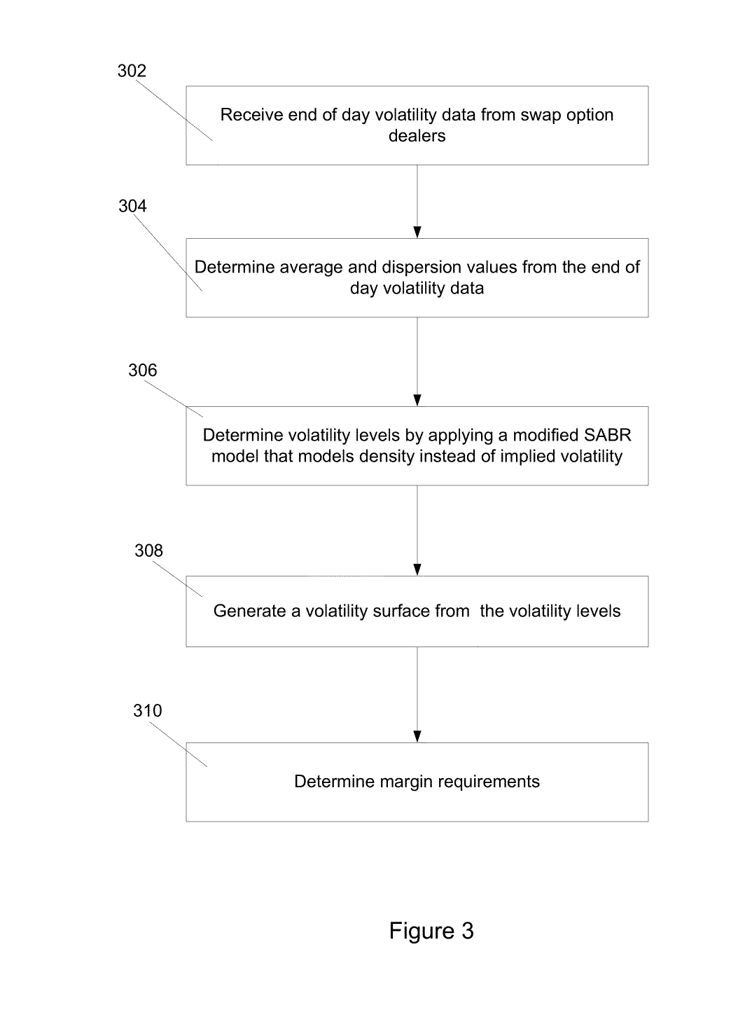

FIG. 3 illustrates a method that may be used to determine volatility levels of swaptions in accordance with an embodiment of the invention. The volatility levels may be used to determine prices and margin requirements. First, in step 302 end of day volatility data is received from swaption dealers. In some embodiments the data may be received from sources in addition to or instead of swaption dealers. The end of day volatility data may include data for swaptions having multiple expiry, tenor and moneyness. The data may include skew normal/log-normal volatility, and prices. Alternative embodiments of the invention may use data determined at times other than end of day.

After the volatility data is received, in step 304 average and dispersion values from the end of day price data may be determined. Step 304 may include blending data received from multiple sources at multiple strike prices. Blending the data prevents outlier data from having an undue influence on the data. In some embodiments the volatility data may be used instead of price data.

Next, in step 306 volatility levels may be determined by applying a modified SABR model that models density instead of implied volatility. The modified SABR model may weight each moneyness with a weight inversely proportional to the dispersion of data received from the swaption dealers. The modified SABR model may be used to fit a smile curve to mid-market values.

One particular modified SABR model for determining volatility is provided below:

$$\{ \begin{matrix}dF = z \cdot σ ( F ) \cdot d {ω}_{1} \\ dz = v \cdot z \cdot d {ω}_{2}\end{matrix} \\ where \\ F ( 0 ) = {F}_{0} , z ( 0 ) = 1 , < d {ω}_{1} , d {ω}_{2} >= ρ dt , σ ( F ) = α {F}^{β} . \\ \{ \begin{matrix}dF = z \cdot σ ( F ) \cdot d {ω}_{1} \\ dz = v \cdot z \cdot d {ω}_{2}\end{matrix} \\ where \\ F ( 0 ) = {F}_{0} , z ( 0 ) = 1 , < d {ω}_{1} , d {ω}_{2} >= ρ dt , σ ( F ) = α {F}^{β}$$

F is underlying

Z is level of volatility

α=initial volatility

ω₁ and ω₁=Brownian noises

β=skewness parameter

One particular modified SABR model for determining volatility is provided below. The “odd power” pow(X;α)=|X|^{α}·sign(X) to simplify the notation. Then

$$y ( X ) = \frac{1}{2 v} [ ( 1 + ρ ) {e}^{X \cdot v} - 2 ρ - ( 1 - ρ ) {e}^{- X \cdot v} ] \\ F ( y ) = C \cdot pow ( pow ( {F}_{0} , 1 - β ) + α \cdot ( 1 - β ) \cdot y ) , \frac{1}{1 - β} )$$

$$p ( X ) = \frac{1}{\sqrt{2 π T}} exp ( - \frac{{X}^{2}}{2 T} )$$

$$Call option = {\int }_{- ∞}^{∞} d Xp ( X ) \cdot max ( F ( y ( X ) ) - K , 0 )$$

$$where C is determined from the condition$$

$${F}_{0} = \int p ( X ) F ( y ( X ) ) d X$$

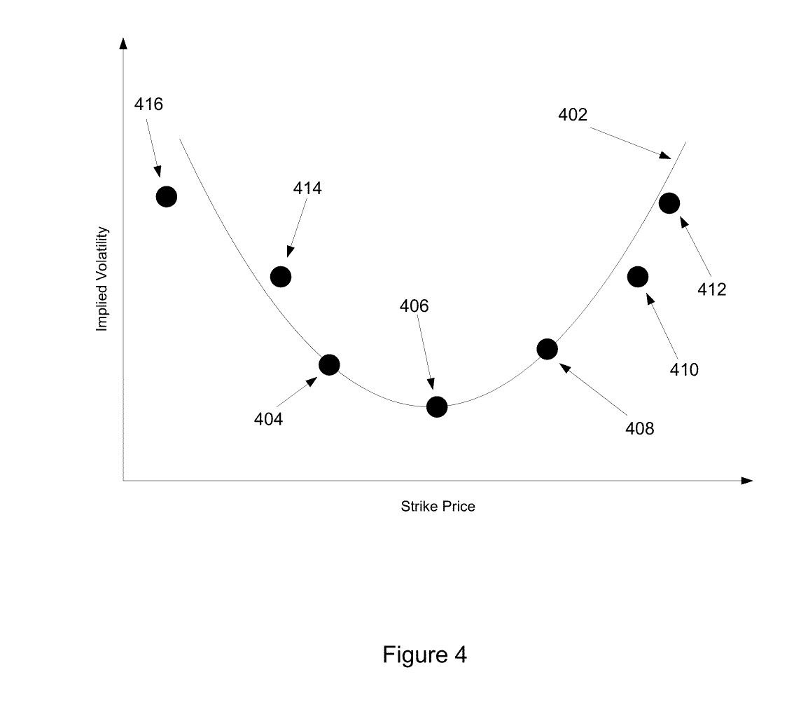

FIG. 4 illustrates an exemplary volatility smile 402 created with a modified SABR model. Points 404-416 represent average or blended data points received from swaption dealers or other sources. The modified SABR model has three degrees of freedom that allows smile 402 to hit three points relatively close to one another 404, 406 and 408. Smile 402 is close to, but does not hit the remaining points.

Once the volatility levels have been determined, a volatility surface may be generated in step 308. Of course, multiple surfaces may be created or the volatility levels may be used to create other types of charts or may be used in other calculations.

In step 310, volatility levels may be used to determine margin account requirements. The margin account requirements may be initial margin account requirements and/or maintenance margin account requirements.

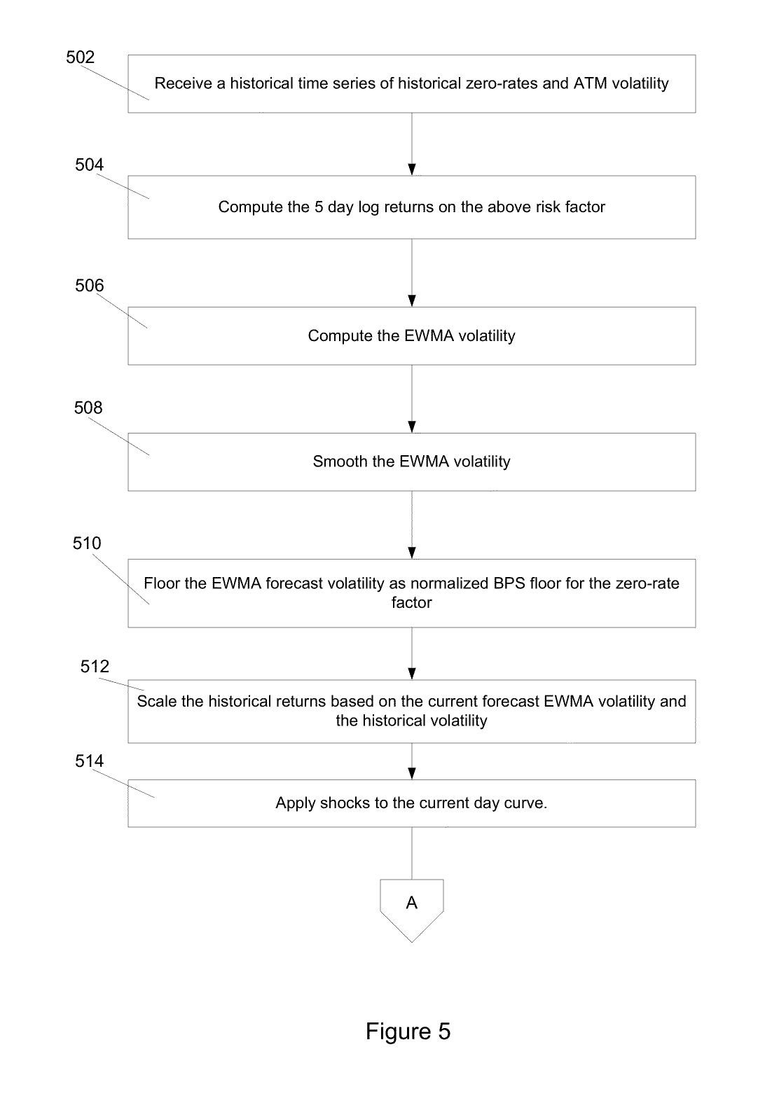

FIG. 5 illustrates an exemplary method for determining margin requirements in accordance with an embodiment of the invention. First, in step 502 a historical time series of historical zero-rates and ATM volatility are received. The historical data may be for a 5 year period. Next, five day log returns are computed on the above risk factors in step 504. The EWMA volatility is computed in step 506. In one embodiment EWMA volatility is computed as follows with a standard EWMA formula:

σ_{t,j}²=(1−λ)r_{t-1,j}²+λσ_{t-1,j}²

Where σ is the EWMA volatility and λ is set at 0.97

In some embodiments absolute return or percentage return may be used instead of log return.

After the EWMA volatility is computed, in step 508 the EWMA volatility may be smoothed. The data may be smoothed using a 10 day moving average for the zero-rate factor. In some embodiments no smoothing is applied to the EWMA volatility for the ATM Volatility factor (IP). Next, in step 510 the EWMA forecast volatility may be floored as normalized BPS floor for the zero-rate factor. A log-normal volatility floor may be applied for the volatility factor (IP). The historical returns may be scaled based on the current forecast EWMA volatility and the historical volatility in step 512 and shocks may be applied to the current day curve in step 514.

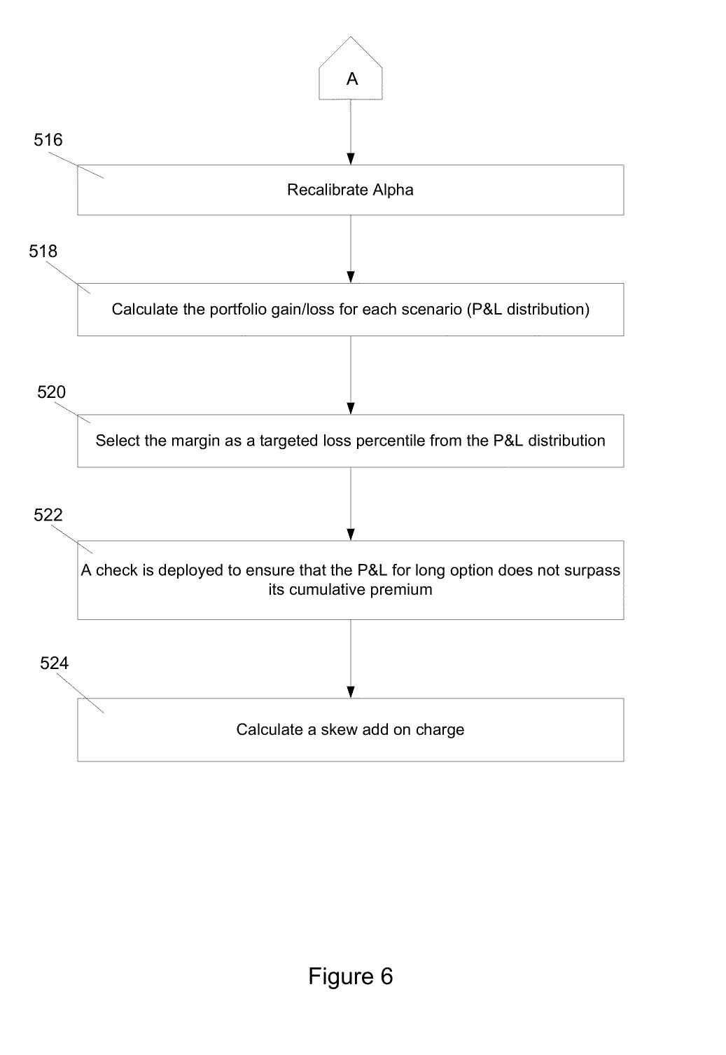

FIG. 6 shows the continuation of the method started in FIG. 5. In step 516 alpha is recalibrated. In various embodiments the inputs to the modified SABR model that is used to price swaptions are ATM forward Rate, Nu1, Nu2, Alpha and Beta. Alpha may be recalibrated for the shock scenarios using scaled ATM volatility and forward rates as derived from the scenario curves (scaled zero rates). The Nu1 and Nu2 parameters for the shock scenarios may be the same as the base scenario (IP). Next, in step 518 the portfolio gain/loss is calculated for each scenario (P&L distribution). The margin as a targeted loss percentile from the P&L distribution may be selected in step 520.

A check may be deployed to ensure that the P&L for long option does not surpass its cumulative premium i.e. long option value in step 522. Step 522 may also ensure that the maximum offset provided by a long position in a portfolio consisting of long and short does not surpass the long option value asymmetric margins. Finally, step 524 a skew add on charge may be calculated. In some embodiments step 524 is performed before step 522. An exemplary method for calculating a skew charge is described below.

The sensitivity of the portfolio to Nu1 and Nu2 may be computed. The skew charge for each scenario may be computed as:

$$Skew {Charge}_{i} = \frac{d P}{d {Nu}_{1}} \times {Nu}_{1} + \frac{d P}{d {Nu}_{2}} \times {Nu}_{2}$$

The skew scenarios may be identified as the 4^{th} worst case loss of five day changes for Nu1 and Nu2 based on historical data only. An indicator for these scenarios may include large parallel moves for a particular tenor and expiry pair, spread and butterfly type moves across the tenor and expiry pairs. A clearinghouse or other entity may add on a few hypothetical but feasible scenarios to capture moves not reflected in historical data. The skew add on charge may then be sampled as the worst case loss from the above distribution.

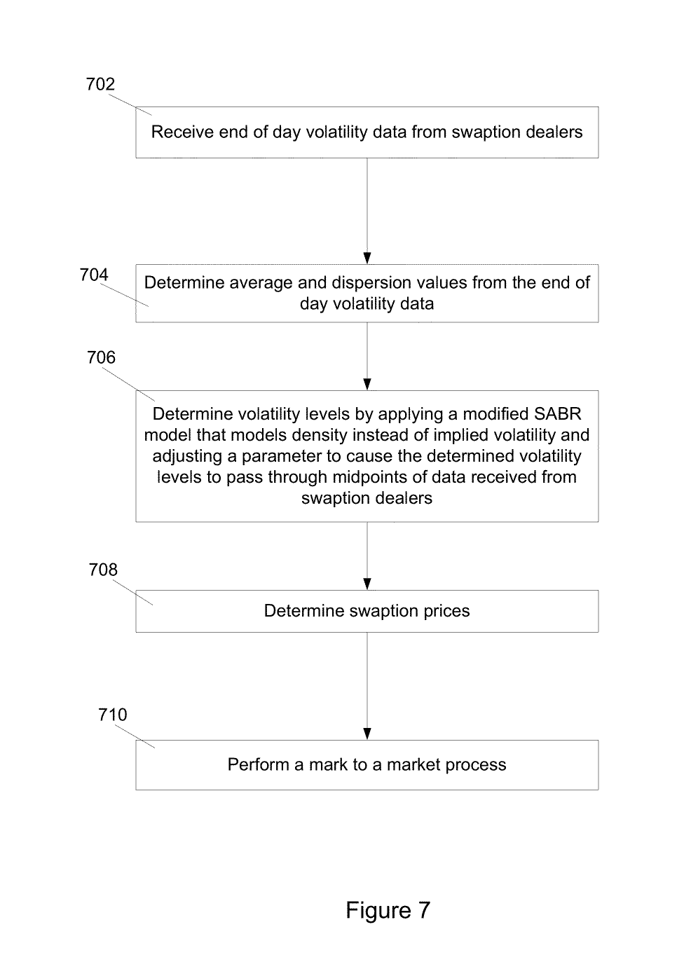

FIG. 7 illustrates a method that may be used to determine volatility levels of swaptions in accordance with an embodiment of the invention. In step 702 end of day volatility data is received from swaption dealers. As mentioned above, in some embodiments the data may be received from sources in addition to or instead of swaption dealers and may be for other time periods. The end of day volatility data may include data for swaptions having multiple expiry, tenor and moneyness. The data may include skew normal/log-normal volatility, and prices.

After the volatility data is received, in step 704 average and dispersion values from the end of day volatility data may be determined. Step 704 may include blending data received from multiple sources at multiple strike prices.

Next, in step 706 volatility levels may be determined by applying a modified SABR model. The modified SABR model may model density instead of implied volatility and may include adjusting a parameter to cause the determined volatility levels to pass through midpoints of data received from swaption dealers.

Step 706 may include first using a SABR model first calibrated to all the market quotes. SABR models generally include parameters α, β, ν, ρ. First parameter, α, is responsible for fitting ATM volatility. The second parameter, β, may be a fixed number. The last two parameters are responsible for fitting the skew and smile of market quotes. In one embodiment, the alpha parameter is implied while keeping the other two parameters, ν, σ, unchanged. The implied alpha parameter may be determined by solving the equation

P(K)=P_{SABR}(α_{K},K,ν,ρ)

with respect to the implied alpha parameter α_{K}. Here P(K) is the swaption value (either call or put) at the strike K and P_{SABR}(α_{K},K,ν,ρ) is a modified SABR pricing formula. This formula may be resolved for swaption expiry and tenor, which results in a three dimensional surface of the SABR parameters. The modified SABR model may weight each moneyness with a weight inversely proportional to the dispersion of data received from the swaption dealers. The modified SABR model may be used to fit a smile curve to mid-market values.

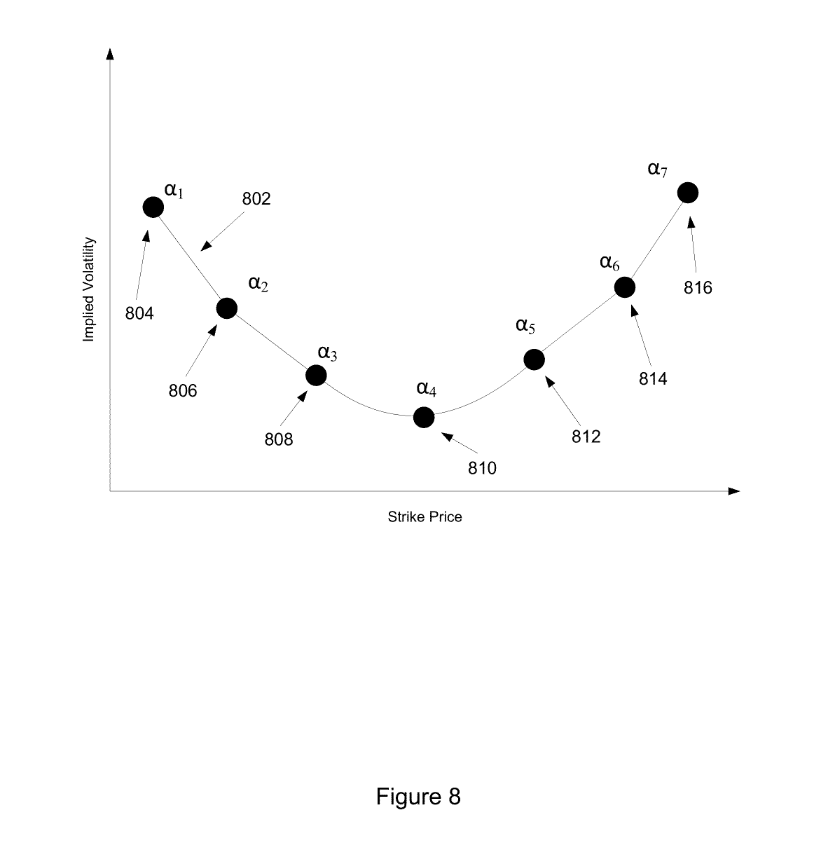

FIG. 8 illustrates an exemplary volatility smile 802 created with the process shown in FIG. 7. Points 804-816 represent average or blended data points received from swaption dealers or other sources. As is shown, each point includes an implied a parameter, which causes volatility smile 802 to pass through midpoints of data points 804-816.

Once the volatility levels have been determined, swaption prices may be determined in step 708 and in step 710 a mark to market process may be performed. The process shown in FIG. 7 may also be used to set initial margin account requirements and/or maintenance margin account requirements.

Another embodiment of the invention includes adjusting a cumulative probability density function (CDF) of a baseline model to determine a volatility smile. This embodiment may be applicable to situations where non-arbitrage interpolation is required. The well-known formula for pricing a European call option on the underlying X:

P_{c}(K)=∫_{-∞}^{∞}dxp(X)(XK)⁺

Here P_{c} is the value of the European call p(X) is the probability density of the underlying at the option maturity, and K is the strike. Similar relation exists in the case of a put price.

The cumulative probability density (CDF) is calculated using:

CDF(K)=∫_{-∞}^{R}dSp(S).

The price of a call option can as well be represented in terms of the cumulative probability density as:

P_{c}(K)=∫_{-∞}^{R}dSCDF(S)dS. (1.)

The process starts with a calibrated modified SBAR model or another model that produces a base line fit within an acceptable tolerance. The base cumulative density is denoted by CDF_{BASE}(S). Base CDF, being inserted in (1) may not be exactly consistent with market option prices. It is desirable to resolve the construct CDF(S) consistent with market quotes for all available strikes.

A cumulative probability density CDF(S) as

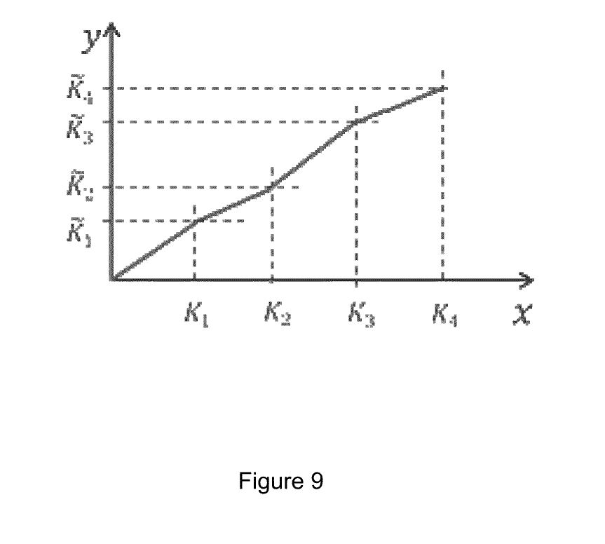

CDF(x)=CDF_{BASE}(y(x)),

where y(x) is piece linear function, as shown in FIG. 9. The function shown in FIG. 9 is fully settled by the adjusted values of strikes R₁,R₂, . . . , R_{N}.

From Eq. (1) one can get that:

$${P}_{σ} ( {K}_{i + 1} ) - {P}_{σ} ( {K}_{i} ) = \frac{{K}_{i + 1} - {K}_{i}}{{K}_{i + 1} - {K}_{i}} {\int }_{{K}_{i}}^{{K}_{i + 1}} {CDF}_{SAB R} ( x ) d x . \qquad ( 2 )$$

This equation can be resolved by the method of bootstrapping. Indeed, assuming that \tilde{K}₁ is known, one can find \tilde{K}ᵢ₊₁ from Eq. (2) with the help of a one dimensional solver, since Rᵢ₊₁ is the only unknown. Solving Eq. (2) step by step starting from ATM quote one can find all adjusted strikes that are larger than the ATM strike. Adjusted strikes below the ATM strike can be found accordingly, based on the prices of put options. The above described procedure allows for the construction of the cumulative density that is consistent with market quotes. Interpolated quotes can be determined from Eq. (1). By construction, an increasing cumulative probability density corresponds to positive probability density. This, in turn, means that the method produces an arbitrage free interpolation.

The selection of which one of the models described above may be a function of the ultimate use of the model. For example, when performing a mark to market process a model that strictly fits data may be used and when performing a margin requirement determination a model that less strictly fits data may be used. Margin requirements may include an additional amount to account for models that less strictly fit data.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. For example, various methods are disclosed herein with steps that are performed in exemplary orders. In alternative embodiments the steps may be performed in other orders without departing from the broader spirit and scope of the invention. All variations and alternative embodiments are considered within the sphere, spirit, and scope of the invention.

1. A method of determining volatility levels for swap options, comprising:
(a) receiving end of day volatility data from swaption dealers;
(b) determining average and dispersion values from the end of day volatility data; and
(c) applying to the end of day volatility data a modified SABR model that models density instead of implied volatility and that uses an implied parameter to cause a volatility smile to pass through average values of the end of day volatility data.

2. The method of claim 1, wherein the modified SABR model includes an α parameter that fits at the money volatility, a ν parameter that fits a skew and a ρ parameter that fits a smile.

3. The method of claim 2, wherein the α parameter is the implied parameter.

4. The method of claim 1, wherein (a) comprises receiving skew normal/log-normal volatility, and price from the swaption dealers.

5. The method of claim 4, wherein (a) comprises receiving data for swaptions having multiple expiry, tenor and moneyness.

6. The method of claim 1, wherein the modified SABR model weighs each moneyness with a weight inversely proportional to the dispersion of data received from the swaption dealers.

7. The method of claim 1, wherein the modified SABR model comprises:
$$y ( X ) = \frac{1}{2 v} [ ( 1 + ρ ) {e}^{X \cdot v} - 2 ρ - ( 1 - ρ ) {e}^{- X \cdot v} ] \\ F ( y ) = C \cdot pow ( pow ( {F}_{0} , 1 - β ) + α \cdot ( 1 - β ) \cdot y ) , \frac{1}{1 - β} )$$
$$p ( X ) = \frac{1}{\sqrt{2 π T}} exp ( - \frac{{X}^{2}}{2 T} )$$
$$Call option = {\int }_{- ∞}^{∞} d Xp ( X ) \cdot max ( F ( y ( X ) ) - K , 0 )$$
$$where C is determined from the condition$$
$${F}_{0} = \int p ( X ) F ( y ( X ) ) d X$$

8. The method of claim 1, further comprising:
(d) generating a volatility surface from the volatility levels determined in (c).

9. The method of claim 1, further including:
(d) performing a mark to market process with the volatility levels determined in (c).

10. The method of claim 1, further including:
(d) determining a margin account requirement with the volatility levels determined in (c).

11. A tangible computer-readable medium containing computer-executable instructions that when executed by a processor cause a computer device to perform the steps comprising:
(a) receiving swaption end of day volatility data;
(b) determining average and dispersion values from the end of day volatility data; and
(c) applying to the end of day volatility data a modified SABR model that models density instead of implied volatility and that uses an implied parameter to cause a volatility smile to pass through average values of the end of day volatility data.

12. The computer-readable medium of claim 11, wherein the modified SABR model includes an α parameter that fits at the money volatility, a ν parameter that fits a skew and a ρ parameter that fits a smile.

13. The computer-readable medium of claim 12, wherein the α parameter is the implied parameter.

14. The computer-readable medium of claim 11, wherein (a) comprises receiving skew normal/log-normal volatility, and price from the swaption dealers.

15. The computer-readable medium of claim 11, wherein (a) comprises receiving data for swaptions having multiple expiry, tenor and moneyness.

16. The computer-readable medium of claim 11, further comprising computer-executable instructions that when executed by a processor cause a computer device to perform the step comprising:
(d) generating a volatility surface from the volatility levels determined in (c).

17. The computer-readable medium of claim 11, further comprising computer-executable instructions that when executed by a processor cause a computer device to perform the step comprising:
(d) performing a mark to market process with the volatility levels determined in (c).

18. A computer system comprising:
a processor;
a tangible computer-readable containing computer executable instructions that when executed by the processor cause the computer system to perform the steps comprising:
(a) receiving swaption end of day volatility data;
(b) determining average and dispersion values from the end of day volatility data; and
(c) applying to the end of day volatility data a modified SABR model that models density instead of implied volatility and that uses an implied parameter to cause a volatility smile to pass through average values of the end of day volatility data.

19. The computer system of claim 18, wherein the modified SABR model includes an α parameter that fits at the money volatility, a ν parameter that fits a skew and a ρ parameter that fits a smile.

20. The computer system of claim 19, wherein the α parameter is the implied parameter.
